(19) United States
(12) Patent Application Publication
(10) Pub. No.: US 2021/0022553 A1
(43) Pub. Date: Jan. 28, 2021

(54) DEEP FRYER WITH OIL AND WATER

(71) Applicants: Andy SUL, Hawaiian Gardens, CA (US); Dabin SUL, South Pasadena, CA (US)

(72) Inventors: Andy SUL, Hawaiian Gardens, CA (US); Dabin SUL, South Pasadena, CA (US)

(21) Appl. No.: 16/520,005

(22) Filed: Jul. 23, 2019

(51) Int. Cl. A47J 37/12

(52) U.S. Cl. CPC A47J 37/1266; A47J 37/129

(57) ABSTRACT

A deep fryer with oil and water comprises an upper container that is adapted to contain oil; a lower container that is adapted to contain oil and water, wherein the lower container is fluid-communicated with the upper container; a heater that heats the oil contained in the upper container; an oil temperature sensor that measures the temperature of the oil contained in the upper container; an oil, water interface sensor that measures amount of impurities in an oil and water interface inside the lower container; a controller that receives data from the oil temperature sensor and the oil water interface sensor and controls the heater; and a housing that encloses the upper container, the lower container, the heater, the oil temperature sensor, the oil water interface sensor and the controller.

### FIELD OF THE INVENTION

The present invention is related to a deep fryer with oil and water. More specifically, the present invention is related to a deep fryer with oil and water having enhanced control for oil and water amount and replacement of oil and water.

### BACKGROUND OF THE INVENTION

deep fry with oil and water makes it possible to use less oil and to remove residues more easily. Controlling temperatures of a water layer and an oil layer above the water layer is the key function of the deep fryer with oil and water. Convenience for total or partial replacement for oil and water, which are inherently difficult because two radically different liquids are present in the deep fryer, is also important.

Heat provided to keep the oil in a designated range must be controlled carefully in order not to overheat the water layer and to keep productivity of frying various kinds of food. Fast and localized heating is important to maximize the advantages of a deep fryer with oil and water.

### BRIEF SUMMARY OF THE INVENTION

An objective of the invention is to provide a deep fryer with oil and water that enables precise concentration of heat for heating the oil.

Another objective of the invention is to provide a deep fryer with oil and water that enables monitoring of residue accumulation from deep frying.

In order to achieve the objectives, the present invention Provides a deep fryer with oil and water comprising an upper container that is adapted to contain oil; a lower container that is adapted to contain oil and water, wherein the lower container is fluid-communicated with the upper container; a heater that heats the oil contained in the upper container; an oil temperature sensor that measures the temperature of the oil contained in the upper container; an oil water interface sensor that measures amount of impurities in an oil and water interface inside the lower container; a controller that receives data from the oil temperature sensor and the oil water interface sensor and controls the heater; and a housing that encloses the upper container, the lower container, the heater, the oil temperature sensor, the oil water interface sensor and the controller.

The heater is positioned inside the upper container.

The upper container has decreasing cross-section toward the lower container.

The peep freer with oil and water further comprises a residue removing pipe connected to the lower container.

The controller controls the heater to release heat at predetermined heat release rate when temperature dropping rate of the oil temperature sensed by the oil temperature sensor exceeds a predetermined value.

The deep fryer with oil and water further comprises a display that displays the oil temperature of the oil in the upper container, and the amount of impurities at the oil and water interface.

The oil water interface sensor measures the transparency of the oil and water interface.

The controller determines the amount of impurities in the oil and water interface based on the transparency of the oil and water interface measured by the oil and water interface sensor.

Alternatively, the oil water interface sensor measures the electric conductivity of the oil and water interface. The controller determines the amount of impurities in the oil and water interface based on the electric conductivity of the oil and water interface measured by the oil and water interface sensor.

The lower container comprises a detachable observation window to observe the oil and water interface.

The advantageous effects of the Present invention are: (1) the controller minimizes oil temperature drop when a batch of food to be deep fried is immersed in the oil in the upper container; (2) the deep fryer keeps optimum operating temperature of the oil; (3) a user can easily determine the timing for removing residue from the oil and water interface.

### BRIEF DESCRIPTION OF THE DRAWINGS

The invention will be more fully understood by reference to the detailed description in conjunction with the following figures, wherein:

FIG. 1 is a front elevation view of a deep fryer with oil and water according to the present invention;

FIG. 2 is a cross-sectional view showing an upper container and a lower container;

FIG. 3 is a schematic diagram showing control of the deep frier with oil and water; and

FIG. 4 is a graph showing temperature change of oil in the upper container.

### DETAILED DESCRIPTION OF THE INVENTION

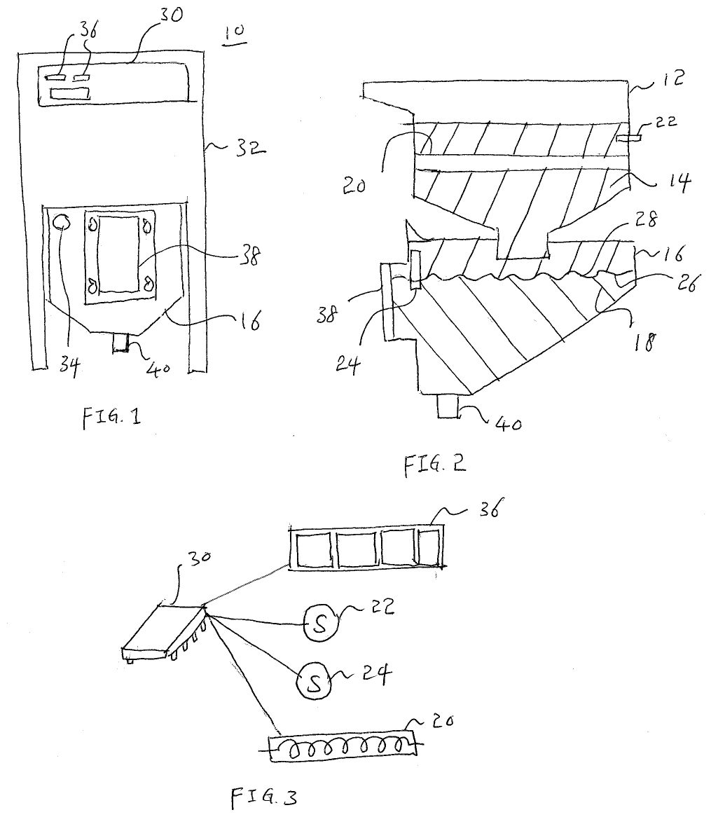

Referring FIGS. 1 and 2, in order to achieve the objectives, the present invention provides a deep fryer with oil and water 10 comprising an upper container 12 that is adapted to contain oil 14; a lower container 16 that is adapted to contain oil 14 and water 18, wherein the lower container 16 is fluid-communicated with the upper container 12; a heater 20 that heats the oil 14 contained in the upper container 12; an oil temperature sensor 22 that measures the temperature of the oil 14 contained in the upper container 12; an oil water interface sensor 24 that measures amount of impurities 28 in an oil and water interface 26 inside the lower container 16; a controller 30 that receives data from the oil temperature sensor 22 and the oil water interface sensor 24 and controls the heater 20; and a housing 32 that encloses the upper container 12, the lower container 16, the heater 20, the oil temperature sensor 22, the oil water interface sensor 24 and the controller 30. The oil temperature sensor 22 is immersed in the oil 14 contained in the upper container 12.

The heater 20 is positioned inside the upper container 12.

The upper container 12 has decreasing cross-section toward the lower container 16.

The deep fryer with oil and water 10 further comprises a residue removing pipe 34 connected to the lower container 16.

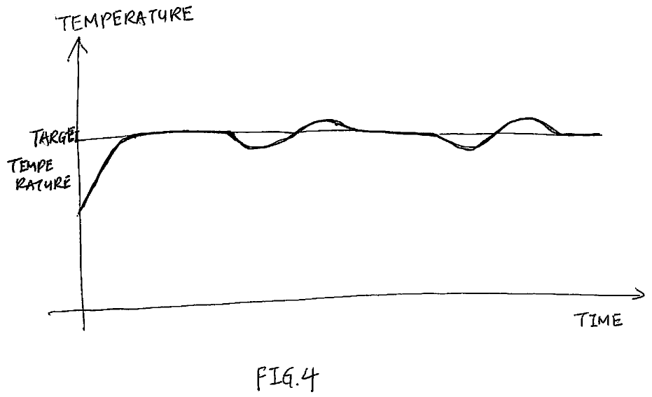

Referring to FIGS. 3 and 4, the controller 30 controls the heater 20 to release heat at predetermined heat release rate when temperature dropping rate of the oil temperature sensed by the oil temperature sensor 22 exceeds a predetermined value. FIG. 4 shows the oil temperature change. The oil 14 is initially heated to a target temperature. When a batch of food is immersed in the heated oil, the oil temperature drops sharply. The controller 30 controls the heater 20 to release a large amount of heat in a short time so that the oil temperature recovers promptly. There might be some overshoot above the target temperature. When the overshoot is detected by the oil temperature sensor 22, the controller 30 decreases the heat output of the heater 20 until the oil temperature is lowed to the target temperature. The Heater 20 may be either gas operated or electric type.

The deep fryer with oil and water further comprises a display 36 that displays the oil temperature of the oil 14 in the upper container 12, and the amount of impurities 28 at the oil and water interface 26.

The oil water interface sensor 24 measures the transparency of the oil and water interface 26. The controller 30 sends signal to the display 36 based on the detected transparency.

The controller 30 determines the amount of impurities 28 in the oil and water interface 26 based on the transparency of the oil and water interface 26 measured by the oil and water interface sensor 24.

Alternatively, the oil water interface sensor 24 measures the electric conductivity of the oil and water interface 26. The controller 30 sends signal to the display 36 based on the detected electric conductivity.

The controller 30 determines the amount of impurities 28 in the oil and water interface 26 based on the electric conductivity of the oil and water interface 26 measured by the oil and water interface sensor 24.

The lower container comprises a detachable observation window 38 to observe the oil and water interface.

The lower container further comprises a drain 40 positioned at the bottom of the lower container.

The above description is illustrative and is not restrictive, and, as it will become apparent to those skilled in the art upon review of the disclosure, the present invention may be embodied in other specific forms without departing from the essential characteristics thereof. The scope of the invention should, therefore, be determined not with reference to the above description, but instead should be determined with reference to the following and pending claims along with scope of equivalents.

1. A deep fryer with oil and water comprising:
a) an upper container that is adapted to contain oil;
b) a lower container that is adapted to contain oil and water, wherein the lower container is fluid-communicated with the upper container;
c) a heater that heats the oil contained in the upper container;
d) an oil temperature sensor that measures the temperature of the oil contained in the upper container;
e) an oil water interface sensor that measures amount of impurities in an oil and water interface inside the lower container;
d) a controller that receives data from the oil temperature sensor and the oil water interface sensor and controls the heater; and
e) a housing that encloses the upper container, the lower container, the heater, the oil temperature sensor, the oil water interface sensor and the controller.

2. The deep fryer with oil and water of claim 1, wherein the heater is positioned inside the upper container.

3. The deep fryer with oil and water of claim 2, wherein the upper container has decreasing cross-section toward the lower container.

4. The deep fryer with oil and water of claim 3, further comprising a residue removing pipe connected to the lower container.

5. The deep fryer with oil and water of claim 4, wherein the controller controls the heater to release heat at Predetermined heat release rate when temperature dropping rate of the oil temperature sensed by the oil temperature sensor exceeds a predetermined value.

6. The deep fryer with oil and water of claim 5, further comprising a display that displays the oil temperature of the oil in the upper container, and the amount of impurities at the oil and water interface.

7. The deep fryer with oil and water of claim 6, wherein the oil water interface sensor measures the transparency of the oil and water interface.

8. The deep fryer with oil and water of claim 7, wherein the controller determines the amount of impurities in the oil and water interface based on the transparency of the oil and water interface measured by the oil and water interface sensor.

9. The deep fryer with oil and water of claim 6, wherein the oil water interface sensor measures the electric conductivity of the oil and water interface.

10. The deep fryer with oil and water of claim 9, wherein the controller determines the amount of impurities in the oil and water interface based on the electric conductivity of the oil and water interface measured by the oil and water interface sensor.

11. The deep fryer with oil and water of claim 10, wherein the lower container comprises a detachable observation window to observe the and water interface.

12. The deep fryer with oil and water of claim 11, wherein the lower container further comprises a drain positioned at the bottom of the lower container.
